(19) United States
(12) Patent Application Publication
(10) Pub. No.: US 2010/0229438 A1
(43) Pub. Date: Sep. 16, 2010

(54) Marking kit

(76) Inventor: Michael Kaperst, Washington, DC (US)

Correspondence Address: DUANE MORRIS LLP - DC, 505 9th Street, Suite 1000, WASHINGTON, DC, 20004-2166, US

(21) Appl. No.: 12/382,311

(22) Filed: Mar. 13, 2009

(51) Int. Cl. G09F 3/10

(52) U.S. Cl. 40/638

(57) ABSTRACT

Disclosed are systems and kits for temporarily marking a plurality of separate objects.

### FIELD OF THE INVENTION

The present invention relates to systems and kits for temporarily marking a plurality of separate objects.

### BACKGROUND OF THE INVENTION

There is a need in many fields for a kit of removable markers for temporarily marking a plurality of separate objects.

For example, during construction of a residence or office, the purchaser of the property is given the opportunity to walk through the property, usually with the builder, and identify any defects or the like that require further attention. At a later time, the builder's employees will then go through the property and repair each defect or the like identified. Prior to that, the builder will have conducted periodic inspections during and after construction to identify any defects, for example in the walls, molding, paint, floors, rails, etc., for repair prior to sale and/or closing.

In its simplest form, blue construction tape or painter's tape is often used during this process to identify or mark such defects because it is easily removed. A purchaser or builder simply tears off a piece of such tape from a roll and affixes it to the desired spot. However, tapes such as these do not characterize or describe the specific defect or the like being identified. Consequently, some defects may remain unresolved because the builder's employees do not realize what specific defect the purchaser was identifying. Other defects may remain unresolved because the builder's employees do not realize that there were multiple defects being identified.

The same sort of situation can arise in connection with rental properties. For example, prior to assuming residence of a rental property, a potential tenant is frequently given the opportunity to walk through the property and identify any defects or damage that should be noted on the lease. Again, however, certain defects or damage can be missed because of inefficient or ineffective marking. Moreover, in the case of pieces of tape, such may be identified by construction or maintenance personnel as scrap, rather than indicative of a defect or damage, and simply remove the tape without repairing the defect or damage.

Another situation where it is desirable to have removable markers is for objects requiring assembly, regardless of whether this is by a manufacturer, a distributor or retailer, or the end purchaser. In such situations, it would be useful to mark the pieces or parts to ensure correct assembly thereof with out leaving mark, or some residue or remnant thereof, on the finished item.

Yet another situation where it would be desirable to have removable markers is in residential or office moving. Removable markers could be applied to various items of furniture or the like to assist in the correct placing of items in the new facility.

In all of the above situations, the markers involved should be easily removable so that they can be removed after the need therefore has passed, without damaging the surface or object to which they were attached.

There is therefore a need for a marking kit for temporarily marking a plurality of objects.

### SUMMARY OF THE INVENTION

It is therefore an object of the present invention to provide a kit for temporarily marking a plurality of separate objects.

It is also an object of the present invention to provide a kit to help users easily identify defects or the like, particularly in connection with ready-to-assemble items, which can then provide data that can be quantified and analyzed. Such quality control processes may, in turn, result in reducing or eliminating defects.

In accordance with this and other objects, a first embodiment of the present invention is directed to a kit for marking a plurality of separate objects. In accordance with this embodiment, the kit comprises a plurality of markers, each of which has a top surface and a bottom surface. On the top surface, each marker has at least one visibly distinguishable identifier, while on at least part of the bottom surface is at least one suitable adhesive.

Other embodiments of the present invention are directed to methods for marking a plurality of objects, for example, in connection with construction and rental walk through, product assembly and quality control, and residential or office moving, by using the kits of the present invention.

It is to be understood that both the foregoing general description and the following detailed description are exemplary and explanatory only and are intended to provide further explanation of the invention as claimed.

### DETAILED DESCRIPTION OF PREFERRED EMBODIMENTS

A first preferred embodiment of the present invention comprises a kit for marking a plurality of separate objects. According to this embodiment of the present invention, the inventive kit comprises a plurality of markers.

Each of the markers in the inventive kit has a top surface and a bottom surface.

On the top surface of each marker is at least one visually distinguishable identifier. Each such visually distinguishable identifier is preferably visible to the naked human eye, although the use of smaller identifiers, which require magnification to observe, is also contemplated for situations where it is desirable and/or necessary.

According to certain preferred embodiments of the present invention, each visually distinguishable marker corresponds to a predetermined entry on an index or key.

For example, in the case of construction walk through each visually distinguishable marker could correspond to an entry on a punch list. Thus, for example, one visually distinguishable marker could correspond to a chip, a second could correspond to a crack, a third could correspond to a dent, a fourth could correspond to a spot or stain, and so forth.

Similarly, in the case of residential or office moving, each visually distinguishable marker could correspond to a particular room on a floor plan.

According to a particularly preferred embodiment of the present invention, the visually distinguishable identifier is an alphanumeric character or string. More preferably, each such alphanumeric character or string is unique. According to certain preferred aspects of this embodiment, for example in connection with residential or office moving, the alphanumeric character or string may correspond to a particular room in the new facility. Similarly, in connection with construction walk through a particular alphanumeric character or string may correspond to a particular defect or the like, for example a “1” or “A” could indicate a chip, “2” or “B” could indicate a crack, “3” or “C” could indicate to a dent, “4” or “D” could indicate a spot or stain, and so forth. Likewise, in connection with the assembly of objects such as furniture, bicycles, grills and the like, the alphanumeric character or string could indicate the sequence in which certain parts are to be joined or could indicate which parts are to be joined together or could be utilized for quality control, particularly in connection with customer feedback.

According to other preferred embodiments of the present invention, the visually distinguishable identifier is a graphic image. According to certain preferred aspects of these embodiments, for example in connection with construction walk thru, the graphic image may be a visual depiction of the defect or the like being identified. Alternatively, the graphic image may be a predetermined image that corresponds to an entry on an index or key.

According to still other preferred embodiments of the present invention, the visually distinguishable identifier is a color. According to certain preferred aspects of this embodiment, for example in connection with residential or office moving, the color may correspond to a particular room in the new facility. Similarly, in connection with construction walk thru, a particular color may correspond to a particular defect or the like, for example red could indicate a chip, blue could indicate a crack, green could indicate to a dent, brown could indicate a spot or stain, and so forth.

According to still other preferred embodiments of the present invention, the visually distinguishable identifier is a shape. According to certain preferred aspects of this embodiment, for example in connection with residential or office moving, the shape correspond to a particular room in the new facility. Similarly, in connection with construction walk thru, a particular shape may correspond to a particular defect or the like, for example circle could indicate a chip, square could indicate a crack, triangle could indicate to a dent, pentagon could indicate a spot or stain, and so forth.

According to still other preferred embodiments of the present invention, the visually distinguishable identifier comprises a combination of two or more of the features described above.

In connection with each of the above embodiments, the inventive kit further comprises a master index or key for correlating each of the visually distinguishable identifiers with a predetermined list.

According to certain embodiments of the inventive marking kit, each of the visually distinguishable identifiers on the component markers is unique. Such an embodiment is particularly preferred when the visually distinguishable identifiers are alphanumeric characters or strings.

According to other embodiments of the inventive marking kit, the component markers are divided into subsets. According to these embodiments, each marker in a given subset has the same visually distinguishable identifier and each subset has a unique visually distinguishable marker.

Such embodiments of the present invention can be real value to end users of the inventive marking kits, including builders, manufacturers and assemblers. More specifically, defects are often hard to quantify without a lot of administration. When properly utilized, the inventive marking kit can provide a quick and efficient measure of defects with little or no administration. For example, on a simple illustrative level, a particular marker is preselected to represent a particular type of defect. If X number of such markers are used, for example in a given time period or with respect to a particular project, this would indicate that there were x number of that particular type of defect present and identified. Different markers could be used to represent different defects commonly encountered. This would readily provide information not only about the overall number of defects, but also the number(s) of particular type(s) of defect(s), with very little oversight or administration required.

In addition to the top surface, each of the markers in the inventive kit further comprises an effective amount of at least one suitable adhesive on at least a portion of said bottom surface thereof.

For purposes of the present invention, a “suitable adhesive” is an adhesive that causes the inventive marker to adhere to a surface of an object being marked until such time as the user intentionally removes the marker from the surface. Preferably, the adhesive does not leave a residue on or adversely affect the surface of the object being marked. Suitable adhesives are known and available to those skilled in the art. Single adhesives may be used, or mixtures of two or more thereof. The choice of a particular adhesive may be made empirically by one skilled in the art depending upon the actual intended use of the inventive marking kit.

Particularly preferred adhesives include the acrylic adhesives (polyacrylates) commonly found on construction or painters tape such as the Scotch-Blue™ tapes commercially available from 3M for multi-surfaces and delicate surfaces. Generally, when using such acrylic adhesives, they are generally present in a weight:weight ratio of 1:1 with respect to the remainder of the marker. Suitable adhesives should be able to retain the marker on the surface of the object being marked for at least 14 days in the absence of any external force, and more preferably for at least 60 days in the absence of any external force, and then should be able to be removed by application of non-mechanical external force without damaging the surface of the object or leaving a residue thereon.

According to certain preferred embodiments, the suitable adhesive (or mixture thereof) is present on the entirety of the bottom surface of each marker.

According to other preferred embodiments, the suitable adhesive (or mixture thereof) is present on only a portion of the bottom surface of each marker. According to such embodiments, the suitable adhesive is present on between 33% and 66% of the bottom surface of each marker.

According to certain embodiments of the present invention, the plurality of markers are placed on a substrate prior to use. According to these embodiments, each marker is removed from the substrate and then applied to a surface of the object being marked. According to certain particularly preferred embodiments, the substrate also contains the master index or key printed or otherwise depicted thereon.

According to other embodiments of the present invention, each of the plurality of markers also includes a backing layer to protect the adhesive prior to use. According to these embodiments, the backing layer is removed from the marker and the marker is then applied to a surface of the object being marked.

The foregoing description and examples are illustrative only and are not intended to limit the scope of the invention as defined by the appended claims. It will be apparent to those skilled in the art that various modifications and variations can be made in the kits of the present invention without departing from the spirit and scope of the invention. Thus, it is intended that the present invention cover the modifications and variations of this invention provided they come within the scope of the appended claims and their equivalents.

What is claimed is:

1. A kit for marking a plurality of separate objects, said kit comprising a plurality of markers, wherein each of said markers has a top surface and a bottom surface, and further wherein each of said markers includes at least one visibly distinguishable identifier on said top surface thereof and an effective amount of at least one suitable adhesive on at least a portion of said bottom surface thereof.

2. The kit according to claim 1, wherein each of said identifiers comprises a predetermined string of one or more alphanumeric characters.

3. The kit according to claim 1, wherein each of said identifiers comprises a predetermined graphic image.

4. The kit according to claim 1, wherein each of said identifiers comprises a predetermined color.

5. The kit according to claim 1, further comprising a master index for correlating each of said markers with a predetermined list.

6. The kit according to claim 1, further comprising a substrate having said plurality of markers removably adhered to at least one surface thereof.

7. The kit according to claim 1, wherein each of said plurality of markers has the same shape.

8. The kit according to claim 1, wherein each of said plurality of markers has a different shape.

9. The kit according to claim 1, wherein each of said plurality of markers in a predetermined subset of said markers has the same shape and each predetermined subset of said markers has a different shape from every other predetermined subset of said markers.

10. The kit according to claim 1, wherein said adhesive is located on substantially the entirety of said back surface.

11. The kit according to claim 1, wherein said adhesive is located on a predetermined portion of said back surface.

12. The kit according to claim 1, wherein each of said identifiers is unique.

13. The kit according to claim 1, wherein said adhesive is a polyacrylate.
